(19) United States
(12) Patent Application Publication
(10) Pub. No.: US 2026/0139130 A1
(43) Pub. Date: May 21, 2026

(54) POLYETHYLENE COMPOSITION FOR A FILM LAYER

(71) Applicant: BOREALIS AG, Vienna (AT)

(72) Inventors: Jingbo WANG, Linz (AT); Friedrich BERGER, Linz (AT)

(73) Assignee: BOREALIS AG, Vienna (AT)

(21) Appl. No.: 19/118,645

(22) PCT Filed: Sep. 21, 2023
(86) PCT No.: PCT/EP2023/076132

§ 371 Date: Apr. 4, 2025

(30) Foreign Application Priority Data
Oct. 5, 2022 (EP) 22199860.2

(51) Int. Cl. C08L 23/08; C08J 5/18

(52) U.S. Cl. CPC C08L 23/08; C08J 5/18; C08J 2323/08; C08J 2423/08; C08L 2203/16; C08L 2205/025; C08L 2205/03; C08L 2207/066; C08L 2207/20; C08L 2314/06

(57) ABSTRACT

The present disclosure relates to a composition including a metallocene catalysed multimodal linear low density polyethylene (mLLDPE) and a HDPE recyclate, and to methods and uses of the composition in film applications, and to a film including the polymer composition of the invention.

The present invention relates to a composition comprising a metallocene catalysed multimodal linear low density polyethylene (mLLDPE) and a HDPE recyclate, to the use of the composition in film applications and to a film comprising the polymer composition of the invention.

Polyolefins, in particular polyethylene and polypropylene are increasingly consumed in large amounts in a wide range of applications, including packaging for food and other goods.

Polyethylene based materials are a particular problem as these materials are extensively used in packaging. Taking into account the huge amount of waste collected compared to the amount of waste recycled back into the stream, there is still a great potential for intelligent reuse of plastic waste streams and for mechanical recycling of plastic wastes. It is thus important to form a circular economy that brings plastic waste back to a second life, i.e., to recycle it. This not only avoids leaving plastic waste in the environment but also recovers its value.

In addition, the European Commission confirmed in 2017 that it would focus on plastics production and use. The EU goals are that 1) by 2025 at least 55% of all plastics packaging in the EU should be recycled and 2) by 2030 all plastic packaging placed in the EU market is reusable or easily recycled. This pushes the brand owners and plastic converters to pursue solutions with recyclate or virgin/recyclate blends.

Thus, there is an increasing importance to include polymers obtained from waste materials for the manufacturing of new products, i.e, wherein waste plastics (e.g. post-consumer recyclate (PCR)) can be turned into resources for new plastic products. Hence, environmental and economic aspects can be combined in recycling and reusing waste plastics material.

However, recycled plastics are normally inferior to virgin plastics in their quality due to degradation, contamination and mixing of different plastics.

In addition, compositions containing recycled polyolefin materials normally have properties, which are much worse than those of the virgin materials, unless the amount of recycled polyolefin added to the final composition is extremely low. For example, such materials often have limited impact strength and poor mechanical properties and thus, they do not fulfil customer requirements.

Blending recycled plastics with virgin plastics is a common practice of improving the quality of recycled plastics.

Based on this it was one objective of the present invention to provide a polyethylene based composition allowing the use of recycled HDPE, which can be used for producing films with good properties, especially good mechanical properties such as impact and stiffness. In addition, it should be possible to add higher amounts of recyclate into the composition.

The inventors have now found that a blend of a metallocene-catalysed multimodal linear low density polyethylene (mLLDPE) made with a specific metallocene catalyst and having a specific polymer design and a HDPE recyclate (i.e. a polyethylene recycling blend), provides films with an improved balance of properties, especially in view of stiffness (i.e. tensile modulus) and impact properties, such as dart drop impact.

### DESCRIPTION OF THE INVENTION

The present invention is therefore directed to a composition comprising
(I) 1.0 to 49.0 wt %, based on the total weight of the composition, of a metallocene catalysed multimodal linear low density polyethylene (mLLDPE), which consists of
(i) 30.0 to 70.0 wt %, based on the total weight of the mLLDPE, of an ethylene-1-butene polymer component (A) and
(ii) 70.0 to 30.0 wt %, based on the total weight of the mLLDPE, of an ethylene-1-hexene polymer component (B),
whereby the ethylene-1-butene polymer component (A) has
   a density (ISO 1183) in the range of 925 to 960 kg/m³ and an MFR₂ (190° C., 2.16 kg, ISO 1133) in the range of 1.0 to 100.0 g/10 min;
the ethylene-1-hexene polymer component (B) has
   a density (ISO 1183) in the range of 880 to 915 kg/m³ and an MFR₂ (190° C., 2.16 kg, ISO 1133) in the range of 0.001 to 1.0 g/10 min; and
whereby the mLLDPE has
   a density (ISO 1183) in the range of from 910 to 925 kg/m³,
   a MFR₂ (190° C., 2.16 kg, ISO 1133) in the range of 0.1 to 2.0 g/10 min and
   a MFR₂₁ (190° C., 21.6 kg, ISO 1133) in the range of 5.0 to 75.0 g/10 min and
   a ratio MFR₂₁/MFR₂ in the range of 15.0 to 60.0; and
(II) 51.0 to 99.0 wt %, based on the total weight of the composition, of a polyethylene recycling blend (PCR) having
(i) a MFR₅ (ISO1133, 5.0 kg; 190° C.) of 0.1 to 10.0 g/10 min, and
(ii) a density (ISO1183) of 950 to 970 kg/m³, and
(iii) a C2 fraction in an amount of above 95.0 wt %, as measured by NMR of the d₂-tetrachloroethylene soluble fraction, and
(iv) a homopolymer fraction (HPF) content, based on the PCR, determined according to Chemical Composition Analysis by Cross Fractionation Chromatography (CFC) in the range of 80.0 to 91.0 wt %, and
(v) a copolymer fraction (CPF) content, based on the PCR, determined according to Chemical Composition Analysis Cross Fractionation Chromatography (CFC) in the range of 9.0 to 20.0 wt %, and
(vi) optionally an iso-PP fraction (IPPF) content, based on the PCR, determined according to Chemical Composition Analysis Cross Fractionation Chromatography (CFC) in the range of 0.0 to 2.0 wt %, whereby said iso-PP fraction (IPPF) is defined as the polymer fraction eluting at a temperature of 104° C. and above, whereby said homopolymer fraction (HPF), said copolymer fraction (CPF), and said iso-PP fraction (IPPF) add up to 100 wt %, and 20)
(vii) inorganic residues (measured by TGA) of 0.01 to 2.00 wt % with respect to the total polyethylene recycling blend and
(viii) OCS gels of size 100 to 299 micrometer measured on 10 m² of a film by an OCS count instrument within the range of 500 to 5000 counts per squaremeter; whereby
(ix) the polyethylene blend has a CIELAB color space (L*a*b*) measured according to DIN EN ISO 11664-4 of
   L* from 75.0 to 86.0;
   a* from −5.0 to 0.0;
   b* from 5.0 to below 25.0
      or
(x) the polyethylene blend has a CIELAB color space (L*a*b*) measured according to DIN EN ISO 11664-4 of
   L* from above 86.0 to 97.0;
   a* from −5.0 to 0.0;
   b* from 0.0 to below 5.0.

In an embodiment of the present invention, the ethylene-1-butene polymer component (A) of the metallocene-catalysed multimodal linear low density polyethylene (mLLDPE) consists of an ethylene polymer fraction (A-1) and an ethylene polymer fraction (A-2), wherein the density (ISO 1183) of fractions (A-1) and (A-2) is in the range of from 925 to 960 kg/m³ and the MFR₂ (190° C., 2.16 kg, ISO 1133) is in the range of from 1.0 to 150.0 g/10 min and wherein the density and/or the MFR₂ (190° C., 2.16 kg, ISO 1133) of ethylene polymer fractions (A-1) and (A-2) may be the same or may be different.

Unexpectedly such a composition provides films with an excellent combination of stiffness and impact, i.e. tensile modulus and dart drop strength.

The invention is therefore further directed to a film comprising at least one layer comprising the composition of the invention.

The specific design of the metallocene catalysed multimodal linear low density polyethylene (mLLDPE) thereby allows the addition of more recyclate and still provides films with good impact/stiffness balance.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed multimodal polyethylene is defined in this invention as multimodal polyethylene with at least two different comonomers selected from alpha-olefins having from 4 to 10 carbon atoms, which has been produced in the presence of a metallocene catalyst.

Polyethylene polymers which have been produced in the presence of a metallocene catalyst, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

For the purpose of the present invention “linear low density polyethylene (LLDPE) which comprises polyethylene component (A) and polyethylene component (B)” means that the LLDPE is produced in an at least 2-stage sequential polymerization process, wherein first component (A) is produced and component (B) is then produced in the presence of component (A) in a subsequent polymerization step, yielding the LLDPE or vice versa, i.e. first component (B) is produced and component (A) is then produced in the presence of component (B) in a subsequent polymerization step, yielding the LLDPE.

LLDPEs produced in a multistage process are also designated as “in-situ” or “reactor” blends. The resulting end-product consists of an intimate mixture of the polymers from the two or more reactors, the different molecular-weight-distribution curves of these polymers together forming a molecular-weight-distribution curve having a broad maximum or two or more maxima, i.e. the end product is a multimodal polymer mixture.

Term “multimodal” in context of multimodal polyethylene means herein multimodality with respect to melt flow rate (MFR) of the ethylene polymer components (A) and (B), i.e. the ethylene polymer components (A) and (B) have different MFR values. The multimodal polyethylene can have further multimodality with respect to one or more further properties between the ethylene polymer components (A) and (B) as well as between fractions (A-1) and (A-2), as will be described later below.

The multimodal linear low density polyethylene (mLLDPE) of the invention as defined above, below or in claims is also referred herein shortly as “mLLDPE”.

The ethylene polymer component (A) and the ethylene polymer component (B), when both mentioned, are also be referred as “ethylene polymer component (A) and (B)”.

The following preferable embodiments, properties and subgroups of the mLLDPE and the ethylene polymer components (A) and (B) thereof, as well as the optional ethylene polymer fractions (A-1) and (A-2) and the film of the invention including the preferable ranges thereof, are independently generalisable so that they can be used in any order or combination to further define the preferable embodiments of the mLLDPE and the article of the invention.

For the purposes of the present description and of the subsequent claims, the term “polyethylene recycling blend (PCR)” is defined as the presence of at least two different polyethylenes such as two high density polyethylenes differing as to their density. For example, a bimodal polyethylene as obtained from two reactors operated under different conditions constitutes a polyethylene blend, in this case an in-situ blend of two reactor products.

It is self explaining that polyethylene blends as obtained from consumer trash will include a broad variety of polyethylenes. In addition to that contamination by other plastics, mainly polypropylene, polystyrene, polyamide, polyesters, wood, paper, limonene, aldehydes, ketones, fatty acids, metals, and/or long term decomposition products of stabilizers can also be found. It goes without saying that such contaminants are not desirable.

It should be understood that the polyethylene recycling blend of the present invention is not a cookie-cutter blend as some of the commercially available recyclates. The polyethylene recycling blend according to the present invention should rather be compared with virgin blends.

The term “C2 fraction” denotes repetitive-[C2H4]-units derived from ethylene which are present in the linear chains backbone and the short chain branches as measured by quantitative 13C{1H} NMR spectroscopy, whereby repetitive means at least two units.

The C2 fraction can be calculated as

$$wtC 2 fraction = fCC 2 total * 100 / ( fCC 2 total + fCPP )$$

whereby

$$fCC 2 total = ( Iddg - ItwoB 4 ) + ( IstarB 1 * 6 ) + ( IstarB 2 * 7 ) + ( ItwoB 4 * 9 ) + ( IthreeB 5 * 10 ) + ( ( IstarB 4 plus - ItwoB 4 - IthreeB 5 ) * 7 ) + ( I 3 s * 3 )$$

$$and$$

$$fCPP = Is αα * 3$$

Details are given in the experimental part.

As HDPE, LDPE or LLDPE, homo- and copolymer polyethylenes are present in recycling blends, analytical separation becomes a must for characterization. An adequate method is Chemical Composition Analysis by Cross fractionation Chromatography (CFC). This method has been described and successfully implemented by Polymer Char, Valencia Technology Par, Gustave Eiffel 8, Paterna E-46980 Valencia, Spain. Chemical Composition Analysis by Cross Fractionation Chromatography (CFC) allows fractionation into a homopolymer fraction (HPF) and a copolymer fraction (CPF) and a potentially present iso-PP fraction (IPPF). The homopolymer fraction (HPF) is a fraction including polyethylenes similar to homopolymer-HDPE. The copolymer fraction (CPF) is a fraction similar to polyethylene HDPE copolymer but can also include fractions of LDPE respectively LLDPE. The iso-PP fraction (IPPF) includes isotactic polypropylenes and is defined as the polymer fraction eluting at a temperature of 104° C. and above. The homopolymer fraction (HPF), the copolymer fraction (CPF) and the potentially present iso-PP fraction (IPPF) add up to 100 wt %. It is self-explaining the 100 wt % refer to the material being soluble within the Cross Fractionation Chromatography (CFC) experiment.

In addition to Chemical Composition Analysis by Cross Fractionation Chromatography (CFC), the polyethylene blend according to the present invention is also characterized by a C2 fraction in an amount of above 95.0 wt %, preferably above 97.0 wt % as measured by NMR of the d2-tetrachloroethylene soluble fraction. The percentage refer to the d2-tetrachloroethylene soluble part as used for the NMR experiment. The term “C2 fraction” equals the polymer fraction obtainable from ethylene monomer units, i.e. not from propylene monomer units.

The upper limit of the “C2 fraction” is 100 wt %.

### Composition

The composition of the present invention comprises, based on the total weight of the composition,
(I) 1.0 to 49.0 wt %, preferably 20.0 to 48.0 wt % and more preferably 30.0 to 45.0 wt % of a metallocene catalysed multimodal linear low density polyethylene (mLLDPE) and
(II) 51.0 to 99.0 wt %, preferably 52.0 to 80.0 wt % and more preferably 55.0 to 70.0 wt % of a polyethylene recycling blend (PCR).

The amount of (I) and (II) preferably add up to 100.0 wt %.

(I) Multimodal mLLDPE as Well as Ethylene Polymer Component (A) and (B) and Ethylene Polymer Fractions (A-1) and (A-2)

The metallocene catalysed multimodal linear low density polyethylene (mLLDPE) is referred herein as “multimodal”, since the ethylene-1-butene polymer component (A), optionally including ethylene polymer fractions (A-1) and (A-2), and ethylene-1-hexene polymer component (B) have been produced under different polymerization conditions resulting in different Melt Flow Rates (MFR, e.g. MFR₂). I.e. the multimodal mLLDPE is multimodal at least with respect to difference in MFR₂ of the ethylene polymer components (A) and (B).

In an embodiment of the present invention, the ethylene-1-butene polymer component (A) is unimodal, i.e. consisting of only one fraction, and in another embodiment the ethylene-1-butene copolymer (A) consists of an ethylene polymer fraction (A-1) and (A-2).

As stated above the MFR₂ of the ethylene polymer components (A) and (B) are different from each other.

The ethylene polymer component (A) has a MFR₂ in the range of 1.0 to 100.0 g/10 min, preferably of 2.0 to 80.0 g/10 min, more preferably of 3.0 to 70.0 g/10 min and even more preferably of 4.0 to 60.0 g/10 min.

The ethylene polymer component (B) has a MFR₂ in the range of 0.001 to 1.0 g/10 min, preferably of 0.002 to 0.8 g/10 min, more preferably of 0.003 to 0.6 g/10 min and even more preferably of 0.004 to 0.4 g/10 min.

In case that the ethylene-1-butene polymer component (A) consists of ethylene polymer fractions (A-1) and (A-2), the MFR₂ of the ethylene polymer fractions (A-1) and (A-2) may be different from each other or may be the same.

The ethylene polymer fractions (A-1) and (A-2) have a MFR₂ in the range of 0.1 to 150.0 g/10 min, preferably of 1.0 to 120.0 g/10 min, more preferably of 2.0 to 100.0 g/10 min and even more preferably of 3.0 to 90.0 g/10 min, like 5.0 to 85.0 g/10 min.

In an embodiment of the invention, the MFR₂ of the ethylene polymer fraction (A-2) is equal or preferably higher than the MFR₂ of the ethylene polymer fraction (A-1).

Thus, the ratio of the MFR₂ of fraction (A-2) to the MFR₂ of the fraction (A-1), i.e. MFR₂ (A-2)/MFR₂ (A-1), is in the range of ≥1.0 to 150, preferably 1.5 to 100, more preferably 2.0 to 60.

The MFR₂ of the multimodal mLLDPE is in the range of 0.1 to 2.0 g/10 min, preferably 0.2 to 1.5 g/10 min and more preferably 0.3 to 1.0 g/10 min.

The multimodal mLLDPE furthermore has a MFR₂₁ (190° C., 21.6 kg, ISO 1133) in the range of 5.0 to 75.0 g/10 min, preferably 8.0 to 50.0 g/10 min, more preferably 10.0 to 30.0 g/10 min.

The ratio of MFR₂₁/MFR₂ of the multimodal mLLDPE is in the range of 15.0 to 60.0, preferably 30.0 to 55.0 and more preferably 40.0 to 50.0.

Naturally, in addition to multimodality with respect to, i.e. difference between, the MFR₂ of ethylene polymer components (A) and (B) the multimodal mLLDPE of the invention can also be multimodal e.g. with respect to the density of the ethylene polymer components (A) and (B).

Preferably, the density of ethylene polymer component (A) is different, preferably higher, than the density of the ethylene polymer component (B).

The density of the ethylene polymer component (A) is in the range of 925 to 960 kg/m³, preferably of 930 to 955 kg/m³, more preferably 932 to 952 kg/m³ and/or the density of the ethylene polymer component (B) is of in the range of 880 to 915 kg/m³, preferably of 890 to 905 kg/m³.

The polymer fractions (A-1) and (A-2) have a density in the range of from 925 to 960 kg/m³, preferably of 928 to 958 kg/m³, more preferably of 930 to 955 kg/m³, like 935 to 952 kg/m³.

The density of polymer fractions (A-1) and (A-2) may be the same or may be different from each other.

The density of the multimodal mLLDPE is in the range of 910 to 925 kg/m³, preferably of 912 to 923 kg/m³, more preferably of 914 to 922 kg/m³ and even more preferably of 915 to 921 kg/m³.

More preferably the multimodal mLLDPE is multimodal at least with respect to, i.e. has a difference between, the MFR₂, the comonomer type as well as with respect to, i.e. has a difference between, the density of the ethylene polymer components, respectively fractions,

(A) and (B), as defined above, below or in the claims including any of the preferable ranges or embodiments of the polymer composition.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene-1-butene polymer component (A) is present in an amount of 30.0 to 70.0 wt % based on the multimodal mLLDPE, preferably in an amount of 32.0 to 55.0 wt % and even more preferably in an amount of 34.0 to 48.0 wt %.

Thus, the ethylene-1-hexene polymer component (B) is present in an amount of 70.0 to 30.0 wt % based on the multimodal mLLDPE, preferably in an amount of 68.0 to 45.0 wt % and more preferably in an amount of 66.0 to 52.0 wt %.

The metallocene catalysed multimodal mLLDPE, can be produced in a 2-stage process, preferably comprising a slurry reactor (loop reactor), whereby the slurry (loop) reactor is connected in series to a gas phase reactor (GPR), whereby the ethylene polymer component (A) is produced in the loop reactor and the ethylene polymer component (B) is produced in GPR in the presence of the ethylene polymer component (A) to produce the multimodal mLLDPE.

In case that the ethylene component (A) of the multimodal mLLDPE consists of ethylene polymer fractions (A-1) and (A-2), the multimodal mLLDPE can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal mLLDPE. In this case, the reaction conditions in the two slurry reactors are chosen in a way that in the two slurry reactors different products in view of MFR and/or density are produced.

Such a process is described inter alia in WO 2016/198273, WO 2021009189, WO 2021009190, WO 2021009191 and WO 2021009192. Full details of how to prepare suitable metallocene catalysed multimodal mLLDPE can be found in these references.

A suitable process is the Borstar PE process or the Borstar PE 3G process.

The metallocene catalysed multimodal mLLDPE according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal mLLDPE. This can counted as part of the first ethylene polymer component (A).

### Catalyst

The metallocene catalysed multimodal mLLDPE used in the process of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment the organometallic compound (C) has the following formula (I):

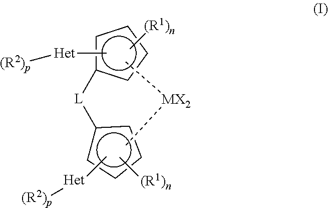

wherein each X is independently a halogen atom, a C1-6-alkyl group, C1-6-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure (I′)

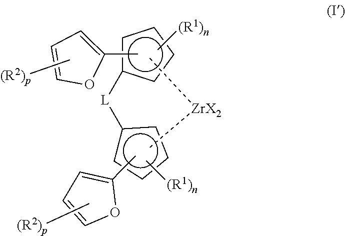

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) or (I′) are

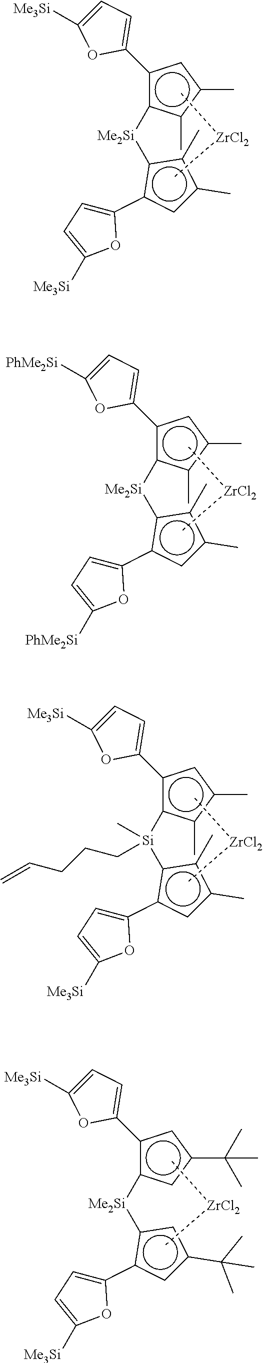

Most preferably the complex dimethylsilanediylbis [2-(5-trimethylsilylfuran-2-yl)-4,5-dimethylcyclopentadien-1-yl] zirconium dichloride is used as organometallic compound (C) of following formula (I).

More preferably the ethylene polymer components (A) and (B) of the multimodal mLLDPE are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

The metallocene catalysed multimodal mLLDPE may contain further polymer components and optionally additives and/or fillers. In case the metallocene catalysed multimodal mLLDPE contains further polymer components, then the amount of the further polymer component(s) typically varies between 3.0 to 20.0 wt % based on the combined amount of the metallocene catalysed multimodal mLLDPE and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so-called master batch, which comprises the respective additive(s) together with a carrier polymer.

### (II) Polyethylene Recycling Blend (PCR)

In addition to the the metallocene catalysed multimodal mLLDPE, the composition of the present invention comprises a polyethylene recycling blend (PCR).

The polyethylene recycling blend (PCR) according to the present invention typically has a melt flow rate MFR₅ (ISO1133, 5.0 kg; 190° C.) of 0.1 to 10.0 g/10 min. The melt flow rate can be influenced by splitting post-consumer plastic waste streams, for example, but not limited to: originating from extended producer's responsibility schemes, like from the German DSD, or sorted out of municipal solid waste into a high number of pre-sorted fractions and recombine them in an adequate way. Usually MFR₅ ranges from 0.5 to 5.0 g/10 min, preferably from 0.7 to 4.0 g/10 min, and most preferably from 1.0 to 3.0 g/10 min. The polyethylene recycling blend (PCR) according to the present invention has a C₂ fraction in amount of above 95.0 wt %, preferably above 97.0 wt %, more preferably above 98.0 wt %, most preferably above 99.0 wt % as measured by NMR of the d2-tetrachloroethylene soluble fraction.

Typically the recycling nature can be assessed by the presence of one or more of the following:
(1) inorganic residues content (measured by TGA) of above 0.01 wt %; and simultaneously OCS gels of size 100 to 299 micrometer measured on 10 m² of film by an OCS count instrument (preferably OCS-FSA100, supplier OCS GmbH (Optical Control System)) within the range of 500 to 5000 counts per squaremeter;
   alternatively or in combination
(2) limonene as determined by using solid phase microextraction (HS-SPME-GC-MS) in an amount of 0.5 ppm or higher;
   alternatively or in combination
(3) fatty acids consisting of the group selected from acetic acid, butanoic acid, pentanoic acid and hexanoic acid as determined by using solid phase microextraction (HS-SPME-GC-MS) in a total amount of 10 ppm or higher.

It should be understood options (2) and (3) are preferred.

“Fatty acids consisting of the group selected from acetic acid, butanoic acid, pentanoic acid and hexanoic acid” means that the individual amounts of acetic acid, butanoic acid, pentanoic acid and hexanoic acid (as determined by HS-SPME-GC-MS in ppm) are added together.

The detection limit for limonene in solid phase microextraction (HS-SPME-GC-MS) is below 0.1 ppm, i.e. traces of these substances easily allow figuring out recycling nature.

It goes without saying that the amounts of inorganic residues, gels, limonene, and fatty acids should be as low as possible.

It is particularly preferred that

limonene as determined by using solid phase microextraction (HS-SPME-GC-MS) is present in an amount of 0.1 to 25 ppm even more preferred 0.1 to 20 ppm; and/or total amount of fatty acids consisting of the group of acetic acid, butanoic acid, pentanoic acid and hexanoic acid as determined by using solid phase microextraction (HS-SPME-GC-MS) are present in a total amount of at least 10 to 500 ppm, more preferably 10 to 300 ppm, most preferably 10 to 180 ppm.

As far as color is concerned, two embodiments can be differentiated: an essentially colorless blend and an essentially white blend.

A first embodiment (the essentially colorless) polyethylene recycling blend (PCR) has a CIELAB color space (L*a*b*) measured according to DIN EN ISO 11664-4 of
L* from 75.0 to 86.0;
a* from −5.0 to 0.0;
b* from 5.0 to below 25.0

A second embodiment (the essentially white) polyethylene recycling blend (PCR) has a CIELAB color space (L*a*b*) measured according to DIN EN ISO 11664-4 of
L* from above 86.0 to 97.0;
a* from −5.0 to 0.0;
b* from 0.0 to below 5.0.

The polyethylene recycling blend (PCR) according to the present invention is preferably characterized by an odor (VDA270-B3) of 2.5 or lower, preferably 2.0 or lower. It should be understood that many commercial recycling grades which do not report odor are in fact even inacceptable in this respect as sniffing tests as set forth by VDA270 are forbidden due to the presence of problematic or toxic substances.

The polyethylene recycling blend (PCR) according to the present invention has one or more of the following OCS gel count properties (measured on 10 m² of film):
size 300 to 599 micrometer: 100 to 2500 counts per squaremeter
size 600 to 1000 micrometer: 5 to 200 counts per squaremeter
size above 1000 micrometer: 1 to 40 counts per squaremeter

The OCS gels are given as counts per squarementer calculated as the average of the 10 m² film measured.

In yet a further aspect, the polyethylene recycling blend (PCR) according to the present invention has a tensile modulus (ISO 527-2 at a cross head speed of 1 mm/min; 23° C.) using injection molded specimens as described in EN ISO 1873-2 (dog bone shape, 4 mm thickness) of at least 825 MPa, preferably at least 850 MPa, most preferably at least 910 MPa. Usually the tensile modulus will not be higher than 1100 MPa. 25

It is also preferred that the polyethylene recycling blend (PCR) does not have units originating from isotactic polypropylene when subjected to NMR analysis as described in the specification.

In yet a further preferred aspect, the polyethylene recycling blend (PCR) according to the present invention has a LAOS-NLF 1000% (190° C.) of 2.1 to 2.9, preferably 2.2 to 2.7 and most preferably 2.3 to 2.6. LAOS-NLF 1000% is a rheological measure of the long chain branching content defined as

$$LAOS - NLF = \vert \frac{{G}_{1}^{′}}{{G}_{3}^{′}} \vert$$

whereby
G₁′ is the first order Fourier Coefficient
G₃′ is the third order Fourier Coefficent

The rather moderate or low value of LAOS-NLF 1000% indicates quite low, i.e. virtually negligible amounts of LDPE or LLDPE. The LAOS-NLF further indicates non-linear polymer structure. Apart from sorting out LDPE and LLDPE, it is possible to influence the LAOS-NLF by mixing several recycling streams (after determination of the value) from different sources for example from different states.

The polyethylene recycling blend (PCR) according to the present invention preferably has a shear thinning factor (STF)

$$STF = \frac{{Eta}^{*} for ( ω = 0.05 rad / s )}{{Eta}^{*} for ( ω = 300 rad / s )}$$

of above 46.0, more preferably from 48.0 to 60.0. The shear thinning factor (STF) indicates processability of a polyethylene. The shear thinning factor (STF) again can be influenced by mixing predetermined streams.

In a further aspect, the polyethylene blend according to the present invention preferably has a polydispersity index (PI)

$$PI = \frac{10 \hat{} 5}{Gc}$$

of above 2.0, more preferably from 2.1 to 2.7,
where Gc is the cross over modulus, being the value of the shear storage modulus, G′, when the shear storage modulus G′ is equal to the shear loss modulus G″. The polydispersity index (PI) is a rheological measurement of the broadness of the molecular weight distribution. Higher values such as above 2.0 or within the range of 2.1 to 2.7 are preferred from the perspective of processability, particularly moldability.

The polyethylene recycling blend according to the present invention is preferably present in the form of pellets. Pelletization contributes to the low amounts of volatile substances and also to homogenisation.

Charpy notched impact strength of the polyethylene recycling blend according to the present invention is preferably higher than 35.0 kJ/m² at 23° C., more preferably higher than 45 kJ/m² at 23° C. At −20° C. the Charpy notched impact strength of the polyethylene blend according to the present invention is preferably higher than 18.0 kJ/m² at 23° C., more preferably higher than 22 kJ/m².

Tensile stress at yield is preferably higher than 25.0 MPa.

The process for providing the polyethylene recycling blend according to the present invention is pretty demanding. The process comprises the following steps:
i) providing post-consumer plastic trash preferably from the separate waste collection or municipal solid waste collecting high purity polyethylene;
ii) sorting out goods made from polystyrene, polyamide, polypropylene, metals, paper and wood thereby providing a post-consumer plastic material; 10)
iii) sorting out colored goods thereby providing a post-consumer plastic material containing mainly white bottles, white yoghurt cups, white cans, colorless panels, colorless component parts and the like whereas steps ii) and iii) can be combined or done separately;
iv) optionally sorting out impurities by manual inspection whereby receiving two streams of polyethylene material, a first stream being essentially transparent and a second stream being essentially of white color;
v) subjecting both streams separately to milling, washing in an aqueous solution with various detergents and subsequent drying, windsifting and screening yielding two pretreated streams;
vi) subjecting the two pretreated streams (both; separately) to a further sorting for eliminating non-polyolefin and colored parts;
vii) extruding into pellets;
viii) optionally aeration which is preferably carried out at a temperature in a range of 100-130° C. by preheating the post-consumer plastic material to such temperature using an air stream having a temperature of at least 100° C. for at least 20 hours.

Aeration is usually necessary but may be skipped under specific circumstances.

Odor control and assessment is possible by a number of methods. An overview is provided inter alia by Demets, Ruben, et al. “Development and application of an analytical method to quantify odour removal in plastic waste recycling processes.” Resources, Conservation and Recycling 161 (2020): 104907 being incorporated by reference herewith.

The inorganic residues may be lowered by solution techniques if necessary. The OCS gel count parameters can be controlled avoiding contaminants such as pigments from colored materials and the like. The manual sorting is preferably assisted by NIR spectroscopy being readily available also in the form of small portable devices. This allows to suppress the polypropylene content to a minimum. Density can be influenced by reducing the amount of relatively flexible polyethylene articles. The relative amounts of homopolymer fraction (HPF) and copolymer fraction (CPF) can be controlled by wind shifting (the machines are also called wind sifters): using an airflow, the materials are separated into various streams depending on the size, shape, and particularly weight of the particles. For example, polyethylene films (i.e. LLDPE/LDPE having relatively high copolymer fraction (CPF)) can be eliminated. CIELAB is controlled by the combination of color sorting and elimination of non-polyethylene polymeric impurities.

### Film of the Invention

The film of the invention comprises at least one layer comprising the composition as described above. The film can be a monolayer film comprising the composition or a multilayer film, wherein at least one layer comprises the composition. The terms “monolayer film” and multilayer film” have well known meanings in the art.

The layer of the monolayer or multilayer film of the invention may consist of the composition of the invention as such or of a blend of the composition together with further polymer(s). In case of blends, any further polymer is different from the metallocene catalysed multimodal mLLDPE and is preferably a polyolefin. Part of the above mentioned additives, like processing aids, can optionally be added to the metallocene catalysed multimodal mLLDPE during the film preparation process.

Preferably, the at least one layer of the invention comprises at least 50 wt %, more preferably at least 60 wt %, even more preferably at least 70 wt %, yet more preferably at least 80 wt %, of the composition of the invention. Most preferably said at least one layer of the film of invention consists of composition.

Accordingly, the films of the present invention may comprise a single layer (i.e. monolayer) or may be multilayered. Multilayer films typically, and preferably, comprise at least 3 layers.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired. Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

The resulting films may have any thickness conventional in the art. The thickness of the film is not critical and depends on the end use. Thus, films may have a thickness of, for example, 300 μm or less, typically 6 to 200 μm, preferably 10 to 180 μm, e.g. 20 to 150 μm or 20 to 120 μm. If desired, the polymer of the invention enables thicknesses of less than 100 μm, e.g. less than 50 μm. Films of the invention with thickness even less than 20 μm can also be produced whilst maintaining good mechanical properties.

Furthermore, the present invention is also directed to the use of the inventive article as packing material, in particular as a packing material for secondary packaging, which do not require a food approval or even for primary packaging for non-food products.

The films of the invention are characterized by a dart-drop impact strength (DDI) determined according to ISO 7765-1:1988, method A on a 40 μm monolayer test blown film of at least 80 g up to 500 g, preferably 90 g to 300 g and more preferably 100 g to 150 g.

Films according to the present invention have good stiffness (tensile modulus measured on a 40 μm monolayer test blown film according to ISO 527-3), i.e. >420 MPa (in both directions).

Thus, the films comprising the composition of the invention may further have a tensile modulus (measured on a 40 μm monolayer test blown film according to ISO 527-3) in machine (MD) in the range of >420 MPa to 900 MPa, preferably of 450 MPa to 850 MPa, more preferably 480 to 800 MPa and in transverse (TD) direction in the range of >520 MPa to 1200 MPa, preferably of 550 MPa to 1150 MPa, more preferably 680 to 1100 MPa.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is determined at 190° C. for polyethylene. MFR may be determined at different loadings such as 2.16 kg (MFR₂), 5 kg (MFR₅) or 21.6 kg (MFR₂₁).

### Calculation of MFR₂ of Component B and of Fraction (A-2)

$$log A = x \cdot log B + ( 1 - x ) \cdot log C$$

$$C = 10 {\hat{}}^{\frac{( logA - x . logB )}{( 1 - x )}}$$

### For Component B:

B=MFR₂ of Component (A)
C=MFR₂ of Component (B)
A=final MFR₂ (mixture) of multimodal medium density polyethylene (mMDPE)
X=weight fraction of Component (A)

For Fraction (A-2):
B=MFR₂ of 1^{st} fraction (A-1)
C=MFR₂ of 2^{nd} fraction (A-2)
A=final MFR₂ (mixture) of loop polymer (=Component (A))
X=weight fraction of the 1st fraction (A-1)

### Density

Density of the polymer was measured according to ISO 1183 and ISO1872-2 for sample preparation and is given in kg/m³.

### C2 Fraction by NMR Spectroscopy and General Microstructure Including “Continuous C3” as Well as Short Chain Branches

Quantitative ¹³C{¹H} NMR spectra were recorded in the solution-state using a Bruker AVNEO 400 MHz NMR spectrometer operating at 400.15 and 100.62 MHz for 1H and 13C respectively. All spectra were recorded using a ¹³C optimised 10 mm extended temperature probehead at 125° C. using nitrogen gas for all pneumatics. Approximately 200 mg of material was dissolved in approximately 3 ml of 1,2-tetrachloroethane-d2 (TCE-d2) along with approximately 3 mg BHT (2,6-di-tert-butyl-4-methylphenol CAS 128-37-0) and chromium-(III)-acetylacetonate (Cr(acac)₃) resulting in a 60 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. Standard single-pulse excitation was employed without NOE, using an optimised tip angle, 1 s recycle delay and a bi-level WALTZ16 decoupling scheme {zhou07, busico07}. A total of 6144 (6k) transients were acquired per spectra.

Quantitative ¹³C{1H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polypropylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3 s 32.2 ppm) were observed. If one or the other structural element is not observable it is excluded from the equations. The intensity of the combined ethylene backbone methine carbons (ddg) containing the polyethylene backbone carbons (dd 30.0 ppm), γ-carbons (g 29.6 ppm) the 4 s and the threeB4 carbon (to be compensated for later on) is taken between 30.9 ppm and 29.3 ppm excluding the Tββ from polypropylene. The amount of C2 related carbons was quantified using all mentioned signals according to the following equation:

$${fC}_{C 2 total} = ( Iddg - ItwoB 4 ) + ( IstarB 1 * 6 ) + ( IstarB 2 * 7 ) + ( ItwoB 4 * 9 ) + ( IthreeB 5 * 10 ) + ( ( IstarB 4 plus - ItwoB 4 - IthreeB 5 ) * 7 ) + ( I 3 s * 3 )$$

When characteristic signals corresponding to the presence of polypropylene (PP, continuous C3) were observed at 46.7 ppm, 29.0 ppm and 22.0 ppm the amount of PP related carbons was quantified using the integral of Sαα at 46.6 ppm:

$${fC}_{P P} = Is αα * 3$$

The weight percent of the C2 fraction and the polypropylene can be quantified according following equations:

$$w {t}_{C 2 fraction} = {fC}_{C 2 total} * 100 / ( {fC}_{C 2 total} + f {C}_{P P} )$$

$$w {t}_{P P} = f {C}_{PP} * 100 / ( {fC}_{C 2 total} + f {C}_{P P} )$$

Characteristic signals corresponding to various short chain branches were observed and their weight percentages quantified as the related branch would be an alpha-olefin, starting by quantifying the weight fraction of each:

$$f wtC 2 = f {C}_{C 2 total} - ( IstarB 1 * 3 ) - ( IstarB 2 * 4 ) - ( ItwoB 4 * 6 ) - ( IthreeB 5 * 7 )$$

$$fwtC 3 ( isolated C 3 ) = IstarB 1 * 3$$

$$fwtC 4 = IstarB 2 * 4$$

$$fwtC 6 = ItwoB 4 * 6$$

$$fwtC 7 = IthreeB 5 * 7$$

Normalisation of all weight fractions leads to the amount of weight percent for all related branches:

$${fsum}_{wt \% total} = fwtC 2 + fwtC 3 + fwtC 4 + fwtC 6 + fwtC 7 + {fC}_{P P}$$

$$wtC 2 total = fwtC 2 * 100 / {fsum}_{wt \% total}$$

$$wtC 3 total = fwtC 3 * 100 / {fsum}_{wt \% total}$$

$$wtC 4 total = fwtC 4 * 100 / {fsum}_{wt \% total}$$

$$wtC 6 total = fwtC 6 * 100 / {fsum}_{wt \% total}$$

$$wtC 7 total = fwtC 7 * 100 / {fsum}_{wt \% total}$$

zhou07
Zhou, Z., Kuemmerle, R., Qiu, X., Redwine, D., Cong, R., Taha, A., Baugh, D. Winniford, B., J. Mag. Reson. 187 (2007) 225
   busico07
Busico, V., Carbonniere, P., Cipullo, R., Pellecchia, R., Severn, J., Talarico, G., Macromol. Rapid Commun. 2007, 28, 1128
   singh09
Singh, G., Kothari, A., Gupta, V., Polymer Testing 28 5 (2009), 475
   randall89
J. Randall, Macromol. Sci., Rev. Macromol. Chem. Phys. 1989, C29, 201.
   brandolini00
A. J. Brandolini, D. D. Hills, NMR Spectra of Polymers and Polymer Additives, Marcel Dekker Inc., 2000

### Polymer Composition Analysis by CFC-Determination of Homopolymer Fraction (HPF), Copolymer Fraction (CPF) and Iso-PP Fraction (IPPF)

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28.

A CFC instrument (PolymerChar, Valencia, Spain) was used to perform the cross-fractionation chromatography (TREF×SEC). A four-band IR5 infrared detector (PolymerChar, Valencia, Spain) was used to monitor the concentration. The polymer was dissolved at 160° C. for 180 minutes at a concentration of around 0.4 mg/ml.

To avoid injecting possible gels and polymers, which do not dissolve in TCB at 160° C., like PET and PA, the weighed out sample was packed into stainless steel mesh MW 0,077/D 0.05 mmm.

Once the sample was completely dissolved an aliquot of 0.5 ml was loaded into the TREF column and stabilized for 60 minutes at 110° C. The polymer was crystallized and precipitated to a temperature of 60° C. by applying a constant cooling rate of 0.07° C./min. A discontinuous elution process is performed using the following temperature steps: (60, 65, 69, 73, 76, 79, 80, 82, 85, 87, 89, 90, 91, 92, 93, 94, 95, 95, 96, 97, 98, 99, 100, 102, 104, 107, 120, 130)

In the second dimension, the GPC analysis, 3 PL Olexis columns and 1× Olexis Guard columns from Agilent (Church Stretton, UK) were used as stationary phase. As eluent 1,2,4-trichlorobenzene (TCB, stabilized with 250 mg/L 2,6-Di tert butyl-4-methyl-phenol) at 150° C.) and a constant flow rate of 1 mL/min were applied. The column set was calibrated using universal calibration (according to ISO 16014-2:2003) with at least 15 narrow MWD polystyrene (PS) standards in the range of 0.5 kg/mol to 11 500 kg/mol. Following Mark Houwink constants were used to convert PS molecular weights into the PE molecular weight equivalents.

$${K}_{P S} = 19 \times {10}^{- 3} mL / g , {α}_{P S} = 0 \text{.655}$$

$${K}_{P E} = 39 \times {10}^{- 3} mL / g , {α}_{P P} = 0.725$$

A third order polynomial fit was used to fit the calibration data. Data processing was performed using the software provided from PolymerChar with the CFC instrument.

### Calculation of the Homopolymer Fraction (HPF) and Copolymer Fraction (CPF) and Iso-PP Fraction (IPPF).

The homopolymer fraction (HPF), copolymer fraction (CPF) and iso-PP fraction (IPPF) are defined in the following way:

$$100 \% = CPF + H PF + IPPF$$

whereby the IPPF fraction is defined as the polymer fraction eluting at a temperature of 104° C. and above.

Due to the slight dependence of the TREF profile on the low MW part, the molecular weight limit of the low MW limit is elution temperature (Tel) dependent. The low MW limit was determined using the following formula:

$$Low M W limit ( for HPF Fraction ) = 0.0125 * {T}_{el} + 2.875$$

Taking this into account the HPF fraction is calculated using the following approach.

$$HPF fraction in wt . - \% = \frac{{\sum }_{i = 60}^{94} {\sum }_{j}^{j = 0.0125 * i + 2.875} {H}_{i j} + {\sum }_{i = 95}^{140} {\sum }_{j = 2}^{8} {H}_{i j} +}{{\sum }_{i = 60}^{140} {\sum }_{j = 2}^{8} {H}_{i j}} - IPP F ( 2 )$$

where Hᵢⱼ is the 2D differential distribution at the corresponded elution temperature (Tel) i and the log M value j, obtained with the corresponded data processing software.

### Inorganic Residues

were determined by TGA according to DIN ISO 11358-1:2014 using a TGA Discovery TGA5500. Approximately 10-30 mg of material were placed in a platinum pan. The sample was heated under nitrogen at a heating rate of 20° C./min. The ash content was evaluated as the weight % at 850° C.

### OCS Gels

A cast film sample of about 70 μm thickness, was extruded and examined with a CCD (Charged-Coupled Device) camera, image processor and evaluation software (Instrument: OCS-FSA100, supplier OCS GmbH (Optical Control System)). The film defects were measured and classified according to their circular diameter. 10 m² of film was analyzed and the value per squaremeter was calculated as the average.

### Cast Film Preparation, Extrusion Parameters:

1. Output 25±4 g/min
2. Extruder temperature profile: 200-210-210-200 (Melt temperature 224° C.)
3. Film thickness about 70 μm
4. Chill Roll temperature 80° C.
5. Airknife 6400 NI/h (volume)

### Technical Data for the Extruder:

1. Screw type: 3 Zone, nitrated
2. Screw diameter: 25 mm
3. Screw length: 25D
4. Feeding zone: 10D
5. Compression zone: 4D+output zone 11D
6. Die 150 mm

The defects were classified according to the size (μm)/m²:
100-299 μm
300-599 μm
600-999 μm
1000 μm and higher

### CIELAB Color Space (L*a*b*)

In the CIE L*a*b* uniform color space, measured according to DIN EN ISO 11664-4, the color coordinates are: L*—the lightness coordinate; a*—the red/green coordinate, with +a* indicating red, and −a* indicating green; and b*—the yellow/blue coordinate, with +b* indicating yellow, and −b* indicating blue. The L*, a*, and b*coordinate axis define the three dimensional CIE color space. Standard Konica/Minolta Colorimeter CM-3700A.

### Evaluation of Recycled Nature

### Limonene Content

Limonene quantification was carried out as described in the experimental part of EP 3757152.

### Fatty Acid Detection

Fatty acid quantification is carried out using headspace solid phase micro-extraction (HS-SPME-GC-MS) by standard addition.

50 mg ground samples are weighed in 20 mL headspace vial and after the addition of limonene in different concentrations and a glass coated magnetic stir bar the vial is closed with a magnetic cap lined with silicone/PTFE. 10 μL Micro-capillaries are used to add diluted free fatty acid mix (acetic acid, propionic acid, butyric acid, pentanoic acid, and hexanoic acid, optionally octanoic acid) standards of known concentrations to the sample at three different levels. Addition of 0, 50, 100 and 500 ng equals 0 mg/kg, 1 mg/kg, 2 mg/kg and 10 mg/kg of each individual acid. For quantification ion 60 acquired in SIM mode is used for all acids except propanoic acid, here ion 74 is used.

### GCMS Parameter:

Column: 20 m ZB Wax plus 0.25*0.25
Injector: Split 5:1 with glass lined split liner, 250° C.
Temperature program: 40° C. (1 min) @6° C./min to 120° C., @15° C. to 245° C. (5 min)
Carrier: Helium 5.0, 40 cm/s linear velocity, constant flow
MS: Single quadrupole, direct interface, 220° C. inter face temperature
Acquisition: SIM scan mode
Scan parameter: 46-250 amu 6.6 scans/s
SIM Parameter: m/z 60.74, 6.6 scans/s.

### Metals

determined by X ray fluorescence (XRF).

### Benzene Content

by HS GC-MS 80° C./2 h, which is described as the following

### Static Headspace Analysis

The parameters of the applied static headspace gas chromatography mass spectrometry (HS/GC/MS) method are described here.

4.000±0.100 g sample were weighed in a 20 ml HS vial and tightly sealed with a PTFE cap.

The mass spectrometer was operated in scan mode and a total ion chromatogram (TIC) was recorded for each analysis. More detailed information on applicable method parameters and data evaluation are given below:
HS parameter (Agilent G1888 Headspace Sampler)
Vial equilibration time: 120 min
Oven temperature: 80° C.
Loop temperature: 205° C.
Transfer line temperature: 210° C.
Low shaking
GC parameter (Agilent 7890A GC System)
Column: ZB-WAX 7HG-G007-22 (30 m×250 μm×1 μm)
Carrier gas: Helium 5.0
Flow: 2 m¹/min
Split: 5:1
GC oven program: 35° C. for 0.1 min
   10° C./min until 250° C.
   250° C. for 1 min
MS parameter (Agilent 5975C inert XL MSD)
Acquisition mode: Scan
Scan parameters:
   Low mass: 20
   High mass: 200
   Threshold: 10
Software/Data evaluation
MSD ChemStation E.02.02.1431
MassHunter GC/MS Acquisition B.07.05.2479
AMDIS GC/MS Analysis Version 2.71
NIST Mass Spectral Library Version 2.0 g
AMDIS deconvolution parameters
Minimum match factor: 80
Threshold: Low
Scan direction: High to Low
Data file format: Agilent files
Instrument type: Quadrupole
Component width: 20
Adjacent peak subtraction: Two
Resolution: High
Sensitivity: Very high
Shape requirements: Medium
Solvent tailing: 44 m/z
Column bleed: 207 m/z
Min. model peaks: 2
Min. S/N: 10
Min. certain peaks: 0.5

### Data Evaluation

The TIC data were further deconvoluted with the aid of AMDIS software (see parameters stated above) and compared to a custom target library which was based on the mass spectral library (NIST). In the custom target library, the respective mass spectra of selected substances (e.g. benzene) were included. Only when the recognised peak showed a minimum match factor of 80 and an experienced mass spectroscopist confirmed the match, a substance was accepted as “tentatively identified”.

In this study, the statement “below the limit of detection (<LOD)” referred to a condition where either the match factor was below 80 (AMDIS) or the peak as such was not even recognised. The results refer solely to the measured samples, time of measurement and the applied parameters.

### Odor VDA270-B3

VDA 270 is a determination of the odor characteristics of trim-materials in motor vehicles. The odor was determined following VDA 270 (2018) variant B3. The odor of the respective sample was evaluated by each assessor according to the VDA 270 scale after lifting the jar's lid as little as possible. The hexamerous scale consists of the following grades: Grade 1: not perceptible, Grade 2: perceptible, not disturbing, Grade 3: clearly perceptible, but not disturbing, Grade 4: disturbing, Grade 5: strongly disturbing, Grade 6: not acceptable. Assessors stay calm during the assessment and are not allowed to bias each other by discussing individual results during the test. They are not allowed to adjust their assessment after testing another sample, either. For statistical reasons (and as accepted by the VDA 270) assessors are forced to use whole steps in their evaluation. Consequently, the odor grade is based on the average mean of all individual assessments, and rounded to whole numbers.

### Rheological Measurements

### Dynamic Shear Measurements (Frequency Sweep Measurements)

The characterisation of melt of polymer composition or polymer as given above or below in the context by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. applying a frequency range between 0.01 and 600 rad/s and setting a gap of 1.3 mm. 30) Further details are described under paragraph i) of the experimental part of EP 3757152.

### Shear Thinning Factor (STF) is Defined as

$$STF = \frac{Eta * for ( ω = 0.05 rad / s )}{Eta * for ( ω = 300 rad / s )}$$

The values are determined by means of a single point interpolation procedure, as defined by Rheoplus software. In situations for which a given G* value is not experimentally reached, the value is determined by means of an extrapolation, using the same procedure as before. Also here cases (interpolation or extrapolation), the option from Rheoplus “−Interpolate y-values to x-values from parameter” and the “logarithmic interpolation type” were applied (see above).

### Large Amplitude Oscillatory Shear (LAOS)

The investigation of the non-linear viscoelastic behavior under shear flow was done resorting to Large Amplitude Oscillatory Shear. The method requires the application of a sinusoidal strain amplitude, γ₀, imposed at a given angular frequency, ω, for a given time, t. Provided that the applied sinusoidal strain is high enough, a non-linear response is generated. The stress, σ is in this case a function of the applied strain amplitude, time and the angular frequency. Under these conditions, the non-linear stress response is still a periodic function; however, it can no longer be expressed by a single harmonic sinusoid. The stress resulting from a non-linear viscoelastic response [0-0] can be expressed by a Fourier series, which includes the higher harmonics contributions:

$$σ ( t , ω , {γ}_{0} ) = {γ}_{0} . {\sum }_{n} [ {G}_{n}^{′} ( ω , {γ}_{0} ) . sin ( n ω t ) + {G}_{n}^{″} ( ω , {γ}_{0} ) . cos ( n ω t ) ] \qquad ( 1 )$$

with, σ—stress response
t—time
ω—frequency
γ₀—strain amplitude
n—harmonic number
G′ₙ—n order elastic Fourier coefficient
G″ₙ—n order viscous Fourier coefficient

The non-linear viscoelastic response was analysed applying Large Amplitude Oscillatory Shear (LAOS). Time sweep measurements were undertaken on an RPA 2000 rheometer from Alpha Technologies coupled with a standard biconical die. During the course of the measurement the test chamber is sealed and a pressure of about 6 MPa is applied. The LAOS test is done applying a temperature of 190° C., an angular frequency of 0.628 rad/s and a strain of 1000%. In order to ensure that steady state conditions are reached, the non-linear response is only determined after at least 20 cycles per measurement are completed. The Large Amplitude Oscillatory Shear Non-Linear Factor (LAOS_NLF) is defined by:

$${LAOS}_{N L F} ( 190 ° C . , 1000 \% ) = \vert \frac{{G}_{1}^{′}}{{G}_{3}^{′}} \vert \qquad ( 2 )$$

where

$${G}_{1}^{′}$$

first order Fourier Coefficient

$${G}_{3}^{′}$$

third order Fourier Coefficient
[1] J. M. Dealy, K. F. Wissbrun, Melt Rheology and Its Role in Plastics Processing: Theory and Applications; edited by Van Nostrand Reinhold, New York (1990)
[2] S. Filipe, Non-Linear Rheology of Polymer Melts, AIP Conference Proceedings 1152, pp. 168-174 (2009)
[3] M. Wilhelm, Macromol. Mat. Eng. 287, 83-105 (2002)
[4] S. Filipe, K. Hofstadler, K. Klimke, A. T. Tran, Non-Linear Rheological Parameters for Characterisation of Molecular Structural Properties in Polyolefins, Proceedings of Annual European Rheology Conference, 135 (2010)
[5] S. Filipe, K. Klimke, A. T. Tran, J. Reussner, Proceedings of Novel Non-Linear Rheological Parameters for Molecular Structural Characterisation of Polyolefins, Novel Trends in Rheology IV, Zlin, Check Republik (2011)
[6] K. Klimke, S. Filipe, A. T. Tran, Non-linear rheological parameters for characterization of molecular structural properties in polyolefins, Proceedings of European Polymer Conference, Granada, Spain (2011)

### Dart Drop Strength (DDI)

The DDI was measured according to ISO 7765-1:1988/Method A from the films (non-oriented films and laminates) as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h at 50±2° C.±10% rh
Test temperature: 23° C.
Dart head material: phenolic
Dart diameter: 38 mm
Drop height: 660 mm
Results: Impact failure weight—50% [g]

### Tensile Modulus

Tensile modulus (E-Mod (MPa) was measured in machine and/or transverse direction according to ISO 527-3 on film samples prepared as described under the Film Sample preparation with film thickness of 40 μm and at a cross head speed of 1 mm/min for the modulus.

### Film Sample Preparation

The test films consisting of the inventive composition and respective comparative compositions of 40 μm thickness, were prepared using a Collin 30 lab scale mono layer blown film line. The film samples were produced at 194° C., a 1:2.5 blow-up ratio, frostline distance of 120 mm.

### Experimental Part

I) mLLDPE

### Cat.Example: Catalyst Preparation for Inventive Examples IE1

### Loading of SiO2:

10 kg of silica (PQ Corporation ES757, calcined 600° C.) was added from a feeding drum and inertized in the reactor until O₂ level below 2 ppm was reached.

### Preparation of MAO/Tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis {2-(5-(trimethylsilyl) furan-2-yl)-4,5-dimethylcyclopentadien-1-yl} zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring was turned to 40 rpm during MAO/tol/MC addition. MAO/tol/MC solution (22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour. After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

Polymerization: Inventive Examples: Multimodal mLLDPE of Ethylene with 1-Butene and 1-Hexene Comonomers for IE

Borstar pilot plant with a 3-reactor set-up (loop1-loop2-GPR 1) and a prepolymerization loop reactor.

The multimodal mLLDPE according to the invention (mLLDPE-1) was produced by using the polymerization conditions as given in table 1.

TABLE 1
Polymerization conditions

mLLDPE-1

Prepoly reactor

| | |
|---|---|
| Temp. (° C.) | 50 |
| Press. (kPa) | 5767 |
| C2 (kg/h) | 4.0 |
| H2 (g/h) | 0.11 |
| C4 (g/h) | 88.7 |
| Split (wt %) | 3.9 |

loop 1

| | |
|---|---|
| Temp. (° C.) | 85 |
| Press. (kPa) | 5231 |
| C2 conc. (mol %) | 4.5 |
| H2/C2 ratio (mol/kmol) | 0.58 |
| C4/C2 ratio (mol/kmol) | 31.4 |
| Split (wt %) | 20.2 |
| Density (kg/m³) of loop 1 material (fraction (A-1)) | 946 |
| MFR₂ (g/10 min) of loop 1 material (fraction (A-1)) | 29.0 |

loop 2

| | |
|---|---|
| Temp. (° C.) | 85 |
| Press. (kPa) | 5355 |
| C2 conc. (mol %) | 4.7 |
| H2/C2 ratio (mol/kmol) | 0.6 |
| C4/C2 ratio (mol/kmol) | 25 |
| Split (wt %) | 22.2 |
| Density (kg/m3) after loop 2 (Component (A)) | 948 |
| MFR₂ (g/10 min) after loop 2 (Component (A)) | 45.0 |
| MFR₂ (g/10 min) of loop 2 material (fraction (A-2)) | 72 |
| Density (kg/m³) of loop 2 material (fraction (A-2)) | 950 |

GPR

| | |
|---|---|
| Temp. (° C.) | 75 |
| Press. (kPa) | 2000 |
| H2/C2 ratio (mol/kmol) | 0.49 |
| C6/C2 ratio (mol/kmol) | 10.57 |
| Split (wt %) | 53.7 |
| MFR₂ (g/10 min) of GPR material (Component | 0.004 |
| (B)) | |
| Density (kg/m³) of GPR material (Component (B)) | 896 |

The polymer was mixed with 2400 ppm of Irganox B561 (provided by BASF) and 270 ppm of Dynamar FX 5922 (provided by 3M) compounded and extruded under nitrogen atmosphere to pellets by using a JSW extruder so that the SEI was 230 kWh/kg and the melt temperature 250° C.

TABLE 2
Material properties of the multimodal mLLDPE-1

| Material | mLLDPE-1 |
|---|---|
| MFR₂ (g/10 min) (final) | 0.30 |
| MFR₂₁ (g/10 min) | 14.0 |
| MFR₂₁/MFR2 | 46.7 |
| MFR₂(A-2)/MFR₂(A-1) | 2.48 |
| Density (kg/m³) | 920 |

### II) Polyethylene Recycling Blend (PCR)

Several post-consumer plastic trash HDPE streams from separate plastic waste collection (civic amenity sites offering specific HDPE collections) were coarsely sorted as to polymer nature and as to color. Impurities were further separated by manual inspection. Two streams were received, i.e. a stream of colorless parts and a stream of white parts. The stream of colorless parts was subjected (separately) to milling, washing in an aqueous solution with various detergents and subsequent drying and screening yielding a pretreated stream. The pretreated stream was further sorted thereby reducing colored parts and non-polyolefins. Upon extrusion into pellets the pellets were subjected to aeration at 120° C. air for 22 hours after pre-heating the substrate pellets to at least 100° C. Essentially colorless PCR was obtained. Results of the final materials are shown in Table 3.

All examples were subjected to Polymer Composition Analysis by CFC.

TABLE 3
Characteristics of the colorless PCR

| | |
|---|---|
| MFR₅ (ISO1133; 190° C./5.0 kg), g/10 min | 2.2 |
| Density, kg/m³; ISO 1183 | 959 |
| C2 fraction (NMR) % | >99.8 |
| HPF (CFC) wt % | 87.5 |
| CPF (CFC) wt % | 12.5 |
| IPPF (CFC)wt % | 0.0 |
| Inorganic residues (TGA), wt %; DIN ISO 1172 | 0.02 |
| OCS gel of size 100 to 299 micrometer (counts / m²) | 871 |
| measured on 10m² film | |
| Limonene (HS-SPME-GC-MS) ppm | 18.9 |
| Fatty acids (acetic+, butanoic + pentanoic + hexanoic) | 239 |
| (HS-SPME-GC-MS) ppm | |
| Acetic acid | 105 |
| Butanoic acid | 26 |
| Pentanoic acid | 25 |
| Hexanoic acid | 83 |
| (HS-SPME-GC-MS) ppm | |
| Color | |
| L* | 83.1 |
| a* | −3.6 |
| b* | 15.2 |
| Limonene (HS-SPME-GC-MS) ppm | 18.9 |
| Fatty acids (acetic+, butanoic + pentanoic + hexanoic) | 239 |
| (HS-SPME-GC-MS) ppm | |
| Benzene presence | <LOD |
| (HS GC-MS 80° C./2 h) | (Limit of Detection) |
| Odor grade VDA270-B3 | 2.0 |
| OCS gel of size 300 to 599 micrometer (counts / m²) | 175 |
| measured on 10 m² film | |
| OCS gel of size 600 to 1000 micrometer (counts / m²) | 21 |
| measured on 10 m² film | |
| OCS gel of size >1000 micrometer (counts / m²) measured | 5 |
| on 10 m² film | |
| Tensile Modulus (ISO527-2), MPa | 980 |
| isotactic polypropylene detectable by NMR? | no |
| LAOS - NLF 1000% 190° C. | 2.58 |
| shear thinning factor (STF) | 49.8 |
| Polydispersity index (PI) | 2.4 |
| Pellets | yes |
| Charpy Notched Impact (NIS) +23° C., kJ/m² | 36.3 |
| Charpy Notched Impact (NIS) −20° C., kJ/m² | 23.0 |
| Tensile stress at yield / MPa | 26.3 |

The multimodal mLLDPE was blended with the polyethylene recycling blend (PCR) and converted into a blown film.

For CE1 Enable 3505CH from ExxonMobile has been used: metallocene catalysed medium density ethylene 1-hexene copolymer; density 935 kg/m³, MFR2 0.5 g/10 min

For CE2 Lumicene® Supertough 40ST05 from Total has been used: metallocene polyethylene; density 940 kg/m³, MFR2 0.5 g/10 min.

For CE3 a Ziegler-Natta catalysed HDPE and a different recyclate, i.e. NAV101, low density polyethylene (LDPE) post-consumer recyclate blend available from Ecoplast Kunststoffrecycling GmbH, have been used:

### CAT2 for Comparative Example 3

For Comparative Example 3 a ZN catalyst as disclosed in EP2994506 has been used.

### Polymerization for Comparative Example 3

Borstar pilot plant with a 2-reactor set-up (loop1-GPR 1) and prepolymerization.

ZN-HDPE was produced using the polymerization conditions as given in Table 4.

TABLE 4
Polymerization conditions for ZN-HDPE

| | ZN-HDPE for |
|---|---|
| | CE3 |
| Catalyst | CAT2 |
| Prepoly loop reactor | |
| Temp. (° C.) | 70 |
| Press. (kPa) | 5700 |
| H2(g/h) | 5.0 |
| Split (wt %) | 1.0 |
| loop | |
| Temp. (° C.) | 95 |
| Press. (kPa) | 5500 |
| C2 conc. (mol %) | 3.5 |
| H2/C2 ratio (mol/kmol) | 430 |
| C4/C2 ratio (mol/kmol) | — |
| Split (wt %) | 48.0 |
| Density (kg/m3) of loop material | 970.0 |
| MFR₂ (g/10 min) of loop material | 350 |
| GPR | |
| Temp. (° C.) | 85 |
| Press. (kPa) | 2000 |
| H2/C2 ratio (mol/kmol) | 110 |
| C4/C2 ratio (mol/kmol) | 25 |
| Split (wt %) | 51 |
| MFR2 (g/10 min) of GPR material | 0.002 |
| Density (kg/m3) of GPR material | 941.6 |

The polymer was mixed with 0.05 wt % Irganox 1010 (BASF), 0.2 wt % Irgafos 168 (BASF) & 0.05 wt % CEASIT FI (Baerlocher) calcium stearate, where wt % are relative to total weight of composition (the sum of HDPE powder+additive=100%) compounded and extruded on a ZSK 57 twin screw extruder. The melt temperature was 210° C., production rate was 200 kg/h.

TABLE 5
Material properties of ZN-HDPE

| Material | HDPE-2 |
|---|---|
| MFR₂ (g/10 min) (final) | 0.80 |
| MFR₂₁ (g/10 min) | 47.35 |
| MFR₂₁/MFR₂ | 59.2 |
| Density (kg/m³) | 956 |

TABLE 6
Properties of NAV 101

| | |
|---|---|
| Ethylene content (wt %) | 90.67 |
| Density (kg/m³) | 923.9 |
| MFR₂ (g/10 min) | 1.02 |
| MFR₅ (g/10 min) | 3.57 |
| MFR₂₁ (g/10 min) | 41.56 |

TABLE 7
blends and film properties

| | unit | IE1 | CE1 | CE2 | CE3 |
|---|---|---|---|---|---|
| mLLDPE | wt % | 40 | | | |
| Enable 3505CH | wt % | | 100 | | |
| Supertough | wt % | | | 100 | |
| 40ST05 | | | | | |
| ZN-HDPE | | | | | 30 |
| PCR | wt % | 60 | | | |
| NAV101 | | | | | 70 |
| Density of blend | kg/m³ | 943 | 935 | 940 | 934 |
| Blown film | | | | | |
| TM/MD | MPa | 516 | 537 | 577 | 347 |
| TM/TD | MPa | 713 | 510 | 654 | 412 |
| DDI | g | 123 | 119 | 128 | 69 |

From the above table it can be clearly seen, that compared to the state of the art virgin materials like Enable and Supertough, the film of the Inventive Example IE1 consisting of the inventive composition has very similar mechanical properties.

If a different blend, e.g. r-LDPE (NAV101) and virgin HDPE like in CE3, is used, worse stiffness and impact of the resulting film is achieved compared to IE1.

1-15. (canceled)

16. A composition comprising:
(I) 1.0 to 49.0 wt %, based on a total weight of the composition, of a metallocene catalysed linear low density polyethylene (mLLDPE), which consists of:
(i) 30.0 to 70.0 wt %, based on a total weight of mLLDPE, of an ethylene-1-butene polymer component (A), and
(ii) 70.0 to 30.0 wt %, based on the total weight of mLLDPE, of an ethylene-1-hexene polymer component (B);
whereby the ethylene-1-butene polymer component (A) has:
a density (ISO 1183) in a range of 925 to 960 kg/m³ and a MFR₂ (190° C., 2.16 kg, ISO 1133) in a range of 1.0 to 100.0 g/10 min;
the ethylene-1-hexene polymer component (B) has:
a density (ISO 1183) in a range of 880 to 915 kg/m³ and a MFR₂ (190° C., 2.16 kg, ISO 1133) in a range of 0.001 to 1.0 g/10 min; and
whereby the mLLDPE has:
a density (ISO 1183) in a range of 910 to 925 kg/m³;
a MFR₂ (190° C., 2.16 kg, ISO 1133) in a range of 0.1 to 2.0 g/10 min,
a MFR₂₁ (190° C., 21.6 kg, ISO 1133) in a range of 5.0 to 75.0 g/10 min,
a ratio MFR₂₁/MFR₂ in a range of 15.0 to 60.0; and
(II) 51.0 to 99.0 wt %, based on a total weight of the composition, of a polyethylene recycling blend (PCR) having:
(i) a MFR₅ (ISO1133, 5.0 kg; 190° C.) of 0.1 to 10 g/10 min, and
(ii) a density (ISO1183) of 950 to 970 kg/m³, and
(iii) a C₂ fraction in an amount of above 95.0 wt %, as measured by NMR of the d2-tetrachloroethylene soluble fraction, and
(iv) a homopolymer fraction (HPF) content, based on the PCR, determined according to Chemical Composition Analysis by Cross Fractionation Chromatography (CFC) in a range of 80.0 to 91.0 wt %, and
(v) a copolymer fraction (CPF) content, based on the PCR, determined according to Chemical Composition Analysis Cross Fractionation Chromatography (CFC) in the range of 9.0 to 20.0 wt %, and
(vi) optionally an iso-PP fraction (IPPF) content, based on the PCR, determined according to Chemical Composition Analysis Cross Fractionation Chromatography (CFC) in a range of 0.0 to 2.0 wt %, whereby said iso-PP fraction (IPPF) is defined as the polymer fraction eluting at a temperature of 104° C. and above, whereby said homopolymer fraction (HPF), said copolymer fraction (CPF), and said iso-PP fraction (IPPF) add up to 100 wt %, and
(vii) inorganic residues (measured by TGA) of 0.01 to 2.00 wt % with respect to the total polyethylene recycling blend, and
(viii) OCS gels of size 100 to 299 micrometer measured on 10 m² of a film by an OCS count instrument within a range of 500 to 5000 counts per squaremeter, whereby
(ix) the polyethylene blend has a CIELAB color space (L*a*b*) measured according to DIN EN ISO 11664-4 of:
L* from 75.0 to 86.0;
a* from −5.0 to 0.0;
b* from 5.0 to below 25.0,
or
(x) the polyethylene blend has a CIELAB color space (L*a*b*) measured according to DIN EN ISO 11664-4 of:
L* from above 86.0 to 97.0;
a* from −5.0 to 0.0;
b* from 0.0 to below 5.0.

17. The composition according to claim 16, wherein in the metallocene catalysed multimodal linear low density polyethylene (mLLDPE) the ethylene-1-butene polymer component (A) consists of:
an ethylene-1-butene polymer fraction (A-1) and an ethylene-1-butene polymer fraction (A-2);
wherein a density (ISO 1183) of fractions (A-1) and (A-2) is in a range of 925 to 960 kg/m³, and the MFR₂ (190° C., 2.16 kg, ISO 1133) is in a range of from 0.1 to 150.0 g/10 min, and wherein a density of each of the ethylene polymer fractions (A-1) and (A-2) is a same or different, and the MFR₂ (190° C., 2.16 kg, ISO 1133) of the ethylene polymer fraction (A-2) is equal to and/or higher than the MFR₂ of the ethylene polymer fraction (A-1).

18. The composition according to claim 16, wherein in the metallocene catalysed multimodal linear low density polyethylene (mLLDPE), the ethylene polymer component (A) has:
a MFR₂ in a range of 2.0 to 80.0 g/10 min, and/or of 3.0 to 70.0 g/10 min, and/or of 4.0 to 60.0 g/10 min; and/or
the ethylene polymer component (B) has a MFR₂ in a range of 0.002 to 0.8 g/10 min, and/or of 0.003 to 0.6 g/10 min, and/or of 0.004 to 0.4 g/10 min.

19. The composition according to claim 17, wherein in the metallocene catalysed multimodal linear low density polyethylene (mLLDPE), a ratio of the MFR₂ of fraction (A-2) to the MFR₂ of the fraction (A-1), MFR₂ (A-2)/MFR₂ (A-1), is in a range of ≥1.0 to 150, and/or 1.5 to 100, and/or 2.0 to 60.

20. The composition according to claim 16, wherein the MFR₂ of the metallocene catalysed multimodal linear low density polyethylene (mLLDPE) is in a range of from 0.2 to 1.5 g/10 min, and/or from 0.3 to 1.0 g/10 min.

21. The composition according to claim 16, wherein in the metallocene catalysed multimodal linear low density polyethylene (mLLDPE), a density (ISO 1183) of the ethylene polymer component (A) is in a range of 930 to 955 kg/m³, and/or 932 to 952 kg/m³;
a density (ISO 1183) of the ethylene polymer component (B) is in a range of 890 to 905 kg/m³; and
a density (ISO 1183) of the metallocene catalysed multimodal linear low density polyethylene (mLLDPE) is in a range of 912 to 923 kg/m³, and/or of 914 to 922 kg/m³, and/or of 915 to 921 kg/m³.

22. The composition according to claim 16, wherein the polyethylene recycling blend (PCR) has one or both of the following properties:
a) limonene content as determined by using solid phase microextraction (HS-SPME-GC-MS) in an amount of 0.1 to 25 ppm, and/or 0.1 to 20 ppm; and
b) total amount of fatty acids consisting of the group of acetic acid, butanoic acid, pentanoic acid and hexanoic acid as determined by using solid phase microextraction (HS-SPME-GC-MS) of 10 to 500 ppm, and/or 10 to 300 ppm.

23. The composition according to claim 16, wherein the polyethylene recycling blend (PCR) has an odor (VDA270-B3) of 2.5 or lower, and/or 2.0 or lower.

24. The composition according to claim 16, wherein the polyethylene recycling blend (PCR) has one or more of the following OCS gel count properties:
a) OCS gels of size 300 to 599 micrometer: 100 to 2500 counts per squaremeter;
b) OCS gels of size 600 to 1000 micrometer: 10 to 200 counts per squaremeter;
c) OCS gels of size above 1000 micrometer: 1 to 40 counts per squaremeter;
all measured on 10 m² of film by an OCS count instrument, measured as described in the experimental part.

25. The composition according to claim 16, wherein the polyethylene recycling blend (PCR) has a tensile modulus (ISO 527-2 at a cross head speed of 1 mm/min; 23° C.) using injection molded specimens as described in EN ISO 1873-2 (dog bone shape, 4 mm thickness) of at least 825 MPa, and/or at least 850 MPa, and/or at least 910 MPa up to 1100 MPa.

26. The composition according to claim 16, wherein the polyethylene recycling blend (PCR) has a Large Amplitude Oscillatory Shear-Non-Linear Factor (LAOS-NLF) (190° C.; 1000%):
$$LAOS - NLF = \vert \frac{{G}_{1}^{′}}{{G}_{3}^{′}} \vert$$
whereby
G₁′ is the first order Fourier Coefficient
G₃′ is the third order Fourier Coefficient
in a range of 2.1 to 2.9, and/or 2.2 to 2.7, and/or 2.3 to 2.6.

27. The composition according to claim 16, wherein the polyethylene recycling blend (PCR) has a shear thinning factor (STF):
$$STF = \frac{Eta * for ( ω = 0.05 rad / s )}{Eta * for ( ω = 300 rad / s )}$$
of above 46.0, and/or from 48.0 to 60.0.

28. A film comprising:
a composition according to claim 16.

29. The film according to claim 28, the film is comprising:
a dart-drop impact strength (DDI) determined according to ISO 7765-1:1988, method A on a 40 μm monolayer test blown film of at least 80 g up to 500 g, and/or 90 g to 300 g, and/or 100 g to 150 g; a tensile modulus (measured on a 40 μm monolayer test blown film according to ISO 527-3) in machine (MD) in a range of from >420 MPa to 900 MPa, and/or of 450 MPa, to 850 MPa, and/or 480 to 800 MPa and in transverse (TD) direction in a range of >520 MPa to 1200 MPa, and/or of 550 MPa to 1150 MPa, and/or 680 to 1100 MPa.

30. The film according to claim 28 in combination as a packing material for secondary packaging which does not require a food approval, or as a primary packaging for non-food products.
